(19) United States
(12) Patent Application Publication
(10) Pub. No.: US 2026/0330287 A1
(43) Pub. Date: Oct. 22, 2026

(54) LIGHTWEIGHT ACTIVE ONLINE MODELING METHOD INTEGRATING MECHANISM AND DYNAMIC MEMORY

(71) Applicant: China University of Mining and Technology, Xuzhou, Jiangsu Province (CN)

(72) Inventors: Wei DAI, Xuzhou, Jiangsu Province (CN); Xin LIU, Xuzhou, Jiangsu Province (CN); Yudong WANG, Xuzhou, Jiangsu Province (CN); Lanhao WANG, Xuzhou, Jiangsu Province (CN); Liang DONG, Xuzhou, Jiangsu Province (CN); Zhenxing XIA, Xuzhou, Jiangsu Province (CN); Zhonghua JIAN, Xuzhou, Jiangsu Province (CN)

(73) Assignee: China University of Mining and Technology, Xuzhou, Jiangsu Province (CN)

(21) Appl. No.: 18/994,780

(22) PCT Filed: Oct. 12, 2024
(86) PCT No.: PCT/CN2024/124294

§ 371 Date: Jan. 15, 2025

(30) Foreign Application Priority Data
Nov. 29, 2023 (CN) 202311611009.1

(51) Int. Cl. G06N 20/00

(52) U.S. Cl. CPC G06N 20/00

(57) ABSTRACT

Disclosed is a lightweight active online modeling method integrating mechanism and dynamic memory, including the following steps: S1: data pre-processing and model initialization; S2: online data representative evaluation based on dynamic memory of process data; S3: online data informativeness evaluation based on dynamic memory of labeled data; S4: mechanism state online monitoring; S5: parallel hybrid active sampling strategy; and S6: soft measurement model online modeling. According to the disclosure, memory strategies for the process data and the labeled data are respectively designed to reserve only high value data, so that lightweight hardware demands are realized. A mechanism state online monitoring method based on a time delay is designed to detect real concept drift of the process. In combination with the dynamic memory and an incremental kernel regression method, a calculated quantity of updating the model and hardware overhead of side deployment are reduced.

### TECHNICAL FIELD

The disclosure relates to the technical field of industrial soft measurements, and particularly relates to a lightweight active online modeling method integrating mechanism and dynamic memory.

### BACKGROUND

The soft measurement technology in rapid development is widely applied to the fields of environmental protection, industry, agriculture, and the like. In particular, extensive research has been conducted on the sensing of many complicated hardly measured data in the industrial process. These methods provide effective data supplementation to industries such as coal dressing, metallurgy, and petrifaction. However, with the actual application of the soft measurement technology in an industrial site, some new problems emerge. Affected by changing factors such as raw material properties, equipment consumption, and operational conditions, data in an actual industrial operation process often has dynamic time-varying characteristics, resulting in that online data hardly meets the independent identically distributed characteristic demand required by a soft measurement model and the soft measurement model is misaligned. In addition, the current soft measurement technology does not fully consider the problem of limited storage and computing force in a real industrial system. In particular, in a current industrial 4.0 large background, in a collaborative transformational development process of an industrial system toward an end cloud edge, there is a problem that whether models can be deployed at edges.

### SUMMARY

In order to overcome deficiencies in the prior art, the disclosure provides a lightweight active online modeling method integrating mechanism and dynamic memory. Objectives are to provide a dynamic memory method for online data, which solves the problem of selectively caching unlimited data in a data stream; provide a mechanism state online monitoring method to find a real concept drift of a process; provide a parallel hybrid active sampling strategy to detect the real concept drift and the virtual concept drift simultaneously to realize high-value sampling of the online data; and in combination with the dynamic memory and an incremental kernel regression method, provide a lightweight online soft measurement model to reduce the computational overhead for updating the model. In order to achieve the above technical objectives, the disclosure adopts the following technical solution:

A lightweight active online modeling method integrating mechanism and dynamic memory, including the following steps:
S1: data pre-processing and model initialization;
S2: online data representative evaluation based on dynamic memory of process data;
S3: online data informativeness evaluation based on dynamic memory of labeled data;
S4: mechanism state online monitoring;
S5: parallel hybrid active sampling strategy; and
S6: soft measurement model online modeling.

Compared with the prior art, the disclosure has the following beneficial effects:

By considering the dynamic time-varying characteristics in the industrial process and the sampling and hardware conditions of industrial sit, the disclosure provides a lightweight active online modeling method integrating mechanism and dynamic memory. By respectively designing memory strategies for the process data and the labeled data to reserve only high value data, only lightweight storage is needed, and the requirements on hardware are reduced. A mechanism state online monitoring method based on a time delay is designed to detect a real concept drift of the process. Furthermore, a parallel hybrid active sampling strategy is provided to detect the real concept drift and a virtual concept drift at the same time to sample high-value data. In combination with the dynamic memory and the incremental kernel regression method, a lightweight online soft measurement model provided, which reduces the calculated quantity of model updating and hardware overhead of edge deployment.

### BRIEF DESCRIPTION OF THE DRAWINGS

In order to describe the embodiments of the disclosure or the technical solution in the related art more clearly, brief introduction on drawings needed to be used in description of the embodiments and the related art will be made below. Apparently, the drawings in the description below are some embodiments of the disclosure, and a person skilled in the art further can obtain other drawings according to the drawings without making creative efforts.

FIG. 1 is a flowchart of a method of the disclosure.

FIG. 2 is a flowchart of a typical dense medium coal dressing process in an embodiment.

FIG. 3 is a display diagram of a soft measurement modeling result.

### DETAILED DESCRIPTION OF THE EMBODIMENTS

The following clearly and completely describes the technical solutions in the embodiments of the disclosure with reference to the accompanying drawings in the embodiments of the disclosure. Apparently, the described embodiments are some of the embodiments of the disclosure rather than all of the embodiments. All other embodiments obtained by those of ordinary skill in the art based on the embodiments of the disclosure without creative work are within the protection scope of the disclosure.

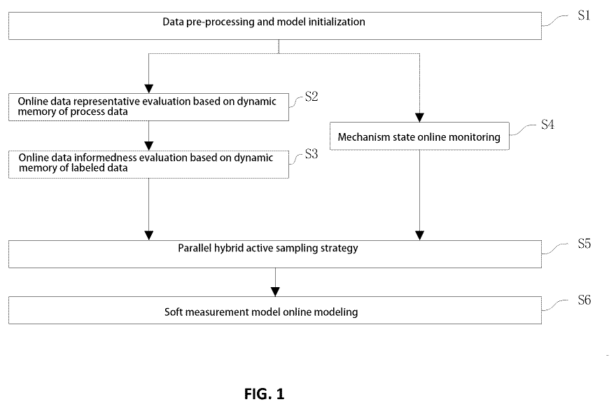

As shown in FIG. 1, a lightweight active online modeling method integrating mechanism and dynamic memory, including the following steps:
S1: data pre-processing and model initialization;
where step S1 specifically includes:
S11: performing mean filtering on collected labeled data to obtain an initial data set Loa;
S12: normalizing the initial data set L_{old} filtered with

$${L}_{n e w} = \frac{{L}_{old} - μ}{σ} ,$$

where μ and σ respectively represent a mean value and a variance of the data, and L_{new} represents the normalized data; and
S13: randomly extracting part of data without replacement from the normalized data set as test set data, and then, randomly extracting part of data without replacement from the normalized data set to simulate data of an unlabeled data stream from the randomly non-replacement extracted part, with the remaining data as a training set for initializing the method.

S2: in order to realize that data in a fixed budget process is only cached for lightweight modeling, introducing the Ebbinghaus' memory law for this purpose for the dynamic memory of the process data, efficiently updating the memory strength of the cached data based on the distance between the online data and the cached data and the time attenuation relation, and updating the data based on the memory strength; and further calculating a local density of the online data by using the cached process data to realize online data representative evaluation;
where step S2 specifically includes:
S21: evaluating representativeness of online data with the process data of the dynamic memory, calculating a local density ld(x_{c}) of the online data and data in a memory window based on a formula

$$l d ( {x}_{c} ) = {\sum }_{{x}_{i} ∈ mw} I ( min dis ( {x}_{i} ) > d i s ( {x}_{c} , {x}_{i} ) )$$

to realize representative evaluation of the online data, where min dis(xᵢ) represents the minimum distance from xᵢ to other data, dis(x_{c}, xᵢ)ᵢ represents a distance between x_{c}, xᵢ, x_{c}, represents new data, xᵢ represent the data in the memory window, mw represents the memory window, and I is a discrimination function;
S22: reading the data stream online, designing a caching strategy for cached data of the process data based on the Ebbinghaus' memory law, making a memory strength equivalent to a cache value of the data, where the memory strength is attenuated over time while being affected by the enhancement of memory reactivation by the online data; when a correlation exists between the memory data and the online data, the minimum distance between the memory data is greater than a distance to new data, regarding that an effective memory exists between the data, and the memory strength of the data with effective memory is enhanced; and if no correlation, the memory strength of the memory data is attenuated over time exponentially, an attenuation factor being as follows:

$${f}_{x} = \frac{1}{{λ}_{x} + 1}$$

fₓ represents an attenuation factor of x, and λ, represents an effective memory number of x; the memory strength attenuates over time and is in reverse proportion to the attenuation factor and is in direct proportion to the memory frequency, the formula being as follows:

sₓ=e^{-f}^{ₓ}^{(t-τ}^{ₓ}⁾
sₓ represents a memory strength, t represents a current time, τₓ represents a time of last effective memory, and e represents an exponential function; and
S23: when the window reaches a data memory upper limit, replacing the data with the smallest memory strength with new data to update the dynamic memory of the data.

S3: online data informativeness evaluation based on the dynamic memory of the labeled data: similarly, in order to realize that the fixed budgeted labeled data is only cached for lightweight modeling, calculating weights of the cached data and the online data according to the informativeness of the data and the forgetting factor, and dynamically caching the labeled data based on the weight of the data; and further calculating the similarity between the online highly representative data and existing cached labeled data by using the kernel method to realize data informativeness evaluation;
where step S3 specifically includes:
S31: evaluating informativeness of online data based on the similarity between feature spaces of the online data and the cached data, a calculation formula being as follows:

$$δ = {‖ {\sum }_{i = 1}^{m} {a}_{i} ϕ ( {d}_{i} ) - ϕ ( {d}_{m + 1} ) ‖}^{2}$$

where φ is a feature vector that maps inputted d into a high-dimensional space, a represents a linear correlation coefficient, i represents a data index, dᵢ represents the cached data, dᵢ∈D, D represents a data matrix, dₘ₊₁ represents the online data, m represents a number of data in the memory window, and the greater the δ is the lower the similarity between the new data and the cached data is, the greater the informativeness of the data is;
S32: determining a by minimizing δ, where the minimization of δ is represented as:

$$a = {min}_{a} [ {a}^{T} K a - 2 {a}^{T} k + k ]$$

where K=k(D, D) is a kernel matrix, k=k(D, dₘ₊₁) is a kernel vector, k=k(dₘ₊₁, dₘ₊₁) is a kernel value, and the property of the kernel value is represented by an inner product of the feature vector to minimize the above formula to obtain the optimum coefficient vector α=K⁻¹k, so as to obtain:

δ=k(dₘ₊₁,dₘ₊₁)−k^{T}α
based on δ, whether the online data is actively sampled and added into the cached data is determined;
S33: when labeled data is newly added, caching the newly added data in two cases:
S331: if the memory window of the labeled data does not reach an upper limit, directly adding the newly added data into the memory window, and updating the cached data for evaluating subsequent memory, calculation formulae being as follows:

$$\begin{matrix}{δ}^{i} = k ( {d}_{i} , {d}_{i} ) - {k}_{n e w}^{iT} {a}_{n e w}^{i} \\ {k}_{n e w}^{i} = {\begin{matrix}[ {k}_{old}^{i} & {k}_{i , m + 1} ]\end{matrix}}^{T} \\ {a}_{n e w}^{i} = \frac{1}{{γ}_{i}} [ \begin{matrix}{γ}_{i} {a}_{old}^{i} + {a}_{i} {a}_{i}^{T} {k}_{old}^{i} - {k}_{i , m + 1} {a}_{i} \\ - {a}_{i}^{T} {k}_{old}^{i} + {k}_{i , m + 1}\end{matrix} ] \\ {α}_{i} = {( {K}_{old}^{i} )}^{- 1} {k}_{m + 1} \\ {γ}_{i} = {k}_{m + 1} - {k}_{m + 1}^{T} {α}_{i}\end{matrix}$$

where δⁱ represents a degree of information of the i^{th} data, k(dᵢ, dᵢ) represents a kernel value of dᵢ itself,

$${a}_{n e w}^{i}$$

represents a linear correlation coefficient after the new data is added,

$${a}_{o l d}^{i}$$

represents a linear correlation coefficient before the new data is added, kₘ₊₁ represents a kernel value of the i^{th} data and the new data,

$${k}_{o l d}^{i}$$

represents a kernel vector before the new data is added,

$${K}_{old}^{i}$$

represents a kernel matrix before the new data is added, kₘ₊₁ represents a kernel vector between the cached data and the new data, and kₘ₊₁ represents a kernel value of the newly added data itself;
S332: if the memory window of the labeled data has reached the upper limit, deleting data with the smallest δ in the memory data to clear memory for the newly added data, wherein δ is calculated based on the following formulae:

$${δ}^{i} = k ( {d}_{i} , {d}_{i} ) - {k}_{new}^{iT} {a}_{new}^{f}$$

$${a}_{n e w}^{i} = A {k}_{n e w}^{i}$$

$${k}_{n e w}^{i} = {[ {k}_{old ( 1 ; j )}^{i} {k}_{i , m + 1} {k}_{old ( j : m )}^{i} ]}^{T}$$

$$A = {A}^{*} - \frac{{{row}_{j} [ {A}^{*} ]}^{T} {r}^{T} {A}^{*}}{1 + {r}^{T} {{row}_{j} [ {A}^{*} ]}^{T}}$$

$${A}^{*} = {( {K}_{old}^{i} )}^{- 1} - \frac{{( {K}_{old}^{i} )}^{1} r {row}_{j} [ {( {K}_{old}^{i} )}^{- 1} ]}{1 + {r}^{T} {{row}_{j} [ {( {K}_{old}^{i} )}^{- 1} ]}^{T}}$$

$$r = {k}_{m + 1} - {{row}_{j} [ {K}_{old}^{i} ]}^{T}$$

where δⁱ represents the degree of information of the i^{th} data, j represents an index of the replaced data, kₘ₊₁ represents a kernel value of the new data, and rowⱼ[A*] represents the j^{th} line of a given matrix A*; and
S34: to simulate attenuation of the informativeness of the data over time, adding a forgetting factor related to time for updating δ, wherein a calculation formula is as follows:

$${λ}^{i} ( t ) = exp ( - \frac{{( t - {t}_{i} )}^{2}}{2 h} )$$

where λ represents the forgetting factor, t represents a current time, tᵢ represents a time when the data is added into the memory, and h represents a forgetting strength;

δⁱ=λⁱδⁱ.
S4: mechanism state online monitoring: identifying a time delay among the variables by using the maximum relevant information to further monitor whether the mechanism changes based on the fluctuation of an online time delay;
where step S4 specifically includes:
S41: analyzing a process mechanism to vary a process with a small time lag into a basic variable, taking a continuous time sequence of the basic variable with a length l at a moment i in real time, and taking a continuous time sequence of the remaining process variable with a length l at a moment i;
S42: calculating the maximum information coefficient of the remaining process sequence and a basic sequence at different time lags, where calculation formulae are as follows:

$$MIC ( x , y ) = {max}_{xy < B ( n )} \frac{I ( x , y )}{{log}_{2} ( min ( x , y ) )}$$

$$I ( x , y ) = {\sum }_{x ∈ X} {\sum }_{y ∈ Y} P ( x , y ) {log}_{2} \frac{P ( x , y )}{P ( x ) P ( y )}$$

where I(x,y) is a mutual information value between x and y, x and y are two sequence data, P(x) and P(y) are probability density functions of x and y, P(x,y) is a joint probability density function, B(n) is 0.5 power of a total sample size n, and time delay corresponding to the maximum time lag sequence with the maximum information coefficient is time delay between the remaining process variable and the basic variable; and
S43: performing online evaluation and monitoring on a time lag relation between the process variable and the basic variable, and when it is detected that a time lag relation changes, considering that the mechanism state changes, and a real drift occurs in the process.
S5: parallel hybrid active sampling strategy: parallelly monitoring mechanism and data distribution changes to detect the real concept drift and the virtual concept drift, so as to realize active sampling of the online data sample:
where step S5 specifically includes:
S51: evaluating the online data representative index in real time, determining and screening representative data based on a threshold to further evaluate the informativeness of the data, and if the informativeness also meets a high informativeness characteristic, i.e., when a cache is not full, the online data δ is greater than a predetermined threshold and when the cache reaches an upper limit, the online data δ is greater than the minimum δ in the cache, triggering an active sampling mechanism; and
S52: parallelly monitoring the process mechanism state in real time, and when a time lag change exceeds a predetermined threshold, considering that the mechanism changes to trigger the active sampling mechanism.
S6: soft measurement model online modeling: combining a Gaussian process regression soft measurement model with an incremental kernel regression method, incrementally learning data obtained by active sampling, and realizing online modeling of the soft measurement model by only updating part of parameters:
where step S6 specifically includes:
S61: a prediction formula for original Gaussian process regression being as follows:

y*=K(X*,X)K(X,X)⁻¹y K(X*,X*)=K(X*,X)K(X,X)⁻¹K(X,X*)
where X represents a process variable of existing data, X* represents a process variable of data to be predicted, y is an output of existing data, y* is an output to be predicted, and K represents a covariance matrix;
S62: when the memory of the labeled data does not reach an upper limit, calculating the incremental update of the covariance matrix

$${K}_{new}^{i}$$

by the following formula:

$${K}_{n e w}^{i} = [ \begin{matrix}{K}_{old}^{i} & {k}_{m + 1} \\ {k}_{m + 1}^{T} & {k}_{m + 1}\end{matrix} ]$$

directly expanding the covariance matrix, where an inverse matrix calculation formula for the expanded covariance matrix is as follows:

$${( {K}_{n e w}^{i} )}^{- 1} = \frac{1}{{γ}_{i}} [ \begin{matrix}{{γ}_{i} ( {K}_{old}^{i} )}^{- 1} + {α}_{i} {α}_{i}^{T} & - {α}_{i} \\ - {a}_{i}^{T} & 1\end{matrix} ]$$

$${α}_{i} = {( {K}_{old}^{i} )}^{- 1} {k}_{m + 1}$$

$${γ}_{i} = {k}_{m + 1} - {α}_{i}^{T} {k}_{m + 1}$$

realizing incremental learning of a Gaussian process regression model that requires only local parameter calculation; and
S63: when data is newly added and the memory of the labeled data has reached the upper limit, replacing the data with minimum δ in the memory with the new data, and calculating the incremental update of the covariance matrix

$${K}_{new}^{i}$$

by the following formula:

$${K}_{n e w}^{i} = [ \begin{matrix}{K}_{old ( 1 ; j )}^{i} & {k}_{m + 1 ( 1 ; j )} & {K}_{o ld ( j ; m )}^{i} \\ {k}_{m + 1 ( 1 ; j )}^{T} & {k}_{m + 1} & {k}_{m + 1 ( j ; m )}^{T} \\ {K}_{old ( j ; m )}^{i T} & {k}_{m + 1 ( j ; m )} & {K}_{o ld ( j ; m )}^{i}\end{matrix} ]$$

j is an index of the replaced data, kₘ₊₁ represents a kernel vector between the cached data and the new data, kₘ₊₁ represents a kernel value of the newly added data itself, and an inverse matrix of the new covariance matrix is calculated based on the following formulae:

$${( {K}_{n e w}^{i} )}^{- 1} = A = {A}^{*} - \frac{{{row}_{j} [ {A}^{*} ]}^{T} {r}^{T} {A}^{*}}{1 + {r}^{T} {{row}_{j} [ {A}^{*} ]}^{T}}$$

$${A}^{*} = {( {K}_{old}^{i} )}^{- 1} - \frac{{( {K}_{old}^{i} )}^{- 1} r {row}_{j} [ {( {K}_{old}^{i} )}^{- 1} ]}{1 + {r}^{T} {{row}_{j} [ {( {K}_{old}^{i} )}^{- 1} ]}^{T}}$$

$$r = {k}_{m + 1} - {{row}_{j} [ {K}_{old}^{i} ]}^{T}$$

realizing incremental learning of a Gaussian process regression model that requires only local parameter calculation.

The dense medium coal dressing process is a typical chemical production process, which is one of the most direct and effective coal dressing methods at present.

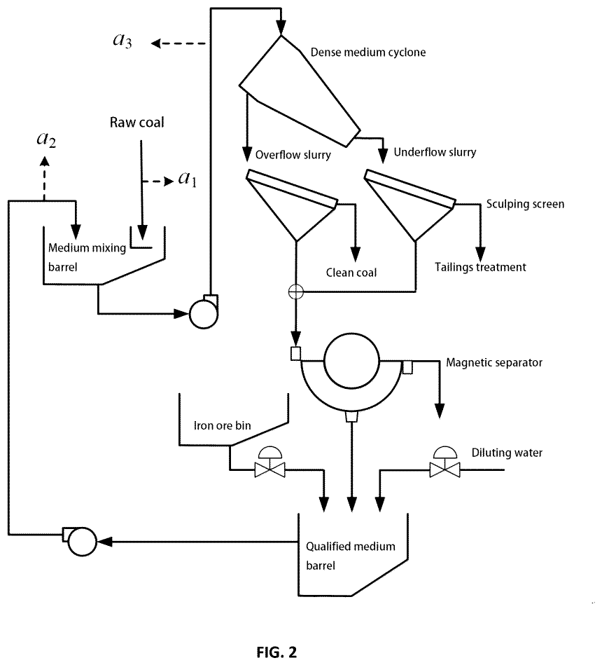

The typical dense medium coal dressing process is shown in FIG. 2, mainly including a coal medium mixing barrel, a dense medium cyclone, a sculping screen, a magnetic separator, an iron ore bin, a qualified medium barrel, a plurality of executors and instruments, and the like. First, deslimed and dehydrated raw coal is conveyed into the coal medium mixing barrel through a belt and is then fully mixed with a dense medium, so as to form a mixed slurry which is pumped into the dense medium cyclone. Then, under the combined action of gravity and a centrifugal force, the slurry in the dense medium cyclone is separated into an overflow slurry and an underflow slurry. The slurry lighter than the medium is suspended at the top of the dense medium cyclone and the slurry heavier than the medium settles at the bottom of the dense medium cyclone. Then, the overflow slurry and the underflow slurry are respectively conveyed to the sculping screen to form a clean coal product and tailings waste, and the remaining slurry is recycled. A medium to be recycled is filtered by the magnetic separator, is then fed into the qualified medium barrel and mixed with magnetite and a certain amount of water, so that a density of the dense medium is maintained within a certain range to guarantee that the recycled dense medium can be directly reused.

Coal dressing ash is an important process index for evaluating coal quality, which is mainly affected by a coal feeding rate, the density of the dense medium, a feeding pressure, and the like. On this basis, a soft measurement model for dense medium cold dressing is established.

200 labeled data are collected for initializing the memory window of the labeled data and the soft measurement model. Then the data stream is read online. The data representativeness is evaluated based on the dynamic memory window of the process data. The informativeness of highly representative data is further calculated based on the dynamic memory window of the labeled data. Moreover, the time delay of the mechanism state is monitored online based on the maximum information coefficient parallelly. Finally, the high-value sample is actively sampled based on the parallel hybrid active sampling strategy, so that the label memory window is further updated, the soft measurement model is incrementally updated online, and the modeling precision is improved.

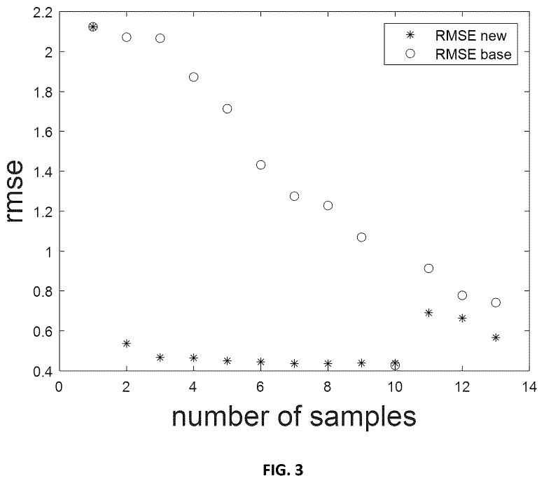

The soft measurement modeling result is shown in FIG. 3. It can be seen that compared with a conventional periodical sampling incremental modeling, modeling errors in the method provided by the disclosure are decreased quickly, the error is lower, and the efficiency is higher. The periodical sampling method needs to increase data points to approach to the effect of the method provided by the disclosure.

What is claimed is:

1. A lightweight active online modeling method integrating mechanism and dynamic memory, comprising the following steps:
S1: data pre-processing and model initialization;
S2: online data representative evaluation based on dynamic memory of process data;
S3: online data informativeness evaluation based on dynamic memory of labeled data;
S4: mechanism state online monitoring;
S5: parallel hybrid active sampling strategy; and
S6: soft measurement model online modeling.

2. The lightweight active online modeling method integrating mechanism and dynamic memory according to claim 1, wherein step S1 specifically comprises:
S11: performing mean filtering on collected labeled data to obtain an initial data set L_{old};
S12: normalizing the initial data set L_{old} filtered with
$${L}_{new} = \frac{{L}_{old} - μ}{σ} ,$$
wherein μ and σ respectively represent a mean value and a variance of the data, and L_{new} represents the normalized data; and
S13: randomly extracting part of data without replacement from the normalized data set as test set data, and then, randomly extracting part of data without replacement from the normalized data set to simulate data of an unlabeled data stream from the randomly non-replacement extracted part, with the remaining data as a training set for initializing the method.

3. The lightweight active online modeling method integrating mechanism and dynamic memory according to claim 1, wherein step S2 specifically comprises:
S21: evaluating representativeness of online data with the process data of the dynamic memory, calculating a local density ld(x_{c}) of the online data and data in a memory window based on a formula
$$ld ( {x}_{c} ) = {\sum }_{{x}_{i} ∈ mw} I ( min dis ( {x}_{i} ) > dis ( {x}_{c} , {x}_{i} ) )$$
to realize representative evaluation of the online data, wherein min dis(xᵢ) represents the minimum distance from xᵢ to other data, dis(x_{c}, xᵢ) represents a distance between x_{c}, xᵢ, x_{c}, represents new data, xᵢ represent the data in the memory window, mw represents the memory window, and I is a discrimination function;
S22: reading the data stream online, designing a caching strategy for cached data of the process data based on the Ebbinghaus' memory law, making a memory strength equivalent to a cache value of the data, wherein the memory strength is attenuated over time while being affected by the enhancement of memory reactivation by the online data; when a correlation exists between the memory data and the online data, the minimum distance between the memory data is greater than a distance to the new data, regarding that an effective memory exists between the data, and the memory strength of the data with effective memory is enhanced; and if no correlation exists, the memory strength of the memory data is attenuated over time exponentially, an attenuation factor being as follows:
$${f}_{x} = \frac{1}{{λ}_{x} + 1}$$
fₓ represents an attenuation factor of x, and λₓ represents an effective memory number of x; the memory strength attenuates over time and is in reverse proportion to the attenuation factor and is in direct proportion to the memory frequency, the formula being as follows:
sₓ=e^{-f}^{ₓ}^{(t-τ}^{ₓ}⁾
sₓ represents a memory strength, t represents a current time, τₓ represents a time of last effective memory, and e represents an exponential function; and
S23: when the window reaches a data memory upper limit, replacing the data with the smallest memory strength with new data to update the dynamic memory of the data.

4. The lightweight active online modeling method integrating mechanism and dynamic memory according to claim 1, wherein step S3 specifically comprises:
S31: evaluating informativeness of online data based on the similarity between feature spaces of the online data and the cached data, a calculation formula being as follows:
$$δ = {‖ {\sum }_{i = 1}^{m} {a}_{i} ϕ ( {d}_{i} ) - ϕ ( {d}_{m + 1} ) ‖}^{2}$$
wherein φ is a feature vector that maps inputted d into a high-dimensional space, a represents a linear correlation coefficient, i represents a data index, dᵢ represents the cached data, d ∈D, D represents a data matrix, dₘ₊₁ represents the online data, m represents a number of data in the memory window, and the greater the δ is, the lower the similarity between the new data and the cached data is, the greater the informativeness of the data is;
S32: determining a by minimizing δ, wherein the minimization of δ is represented as:
$$a = {min}_{a} [ {a}^{T} K a - 2 {a}^{T} k + k ]$$
wherein K=k(D, D) is a kernel matrix, k=k(D, dₘ₊₁) is a kernel vector, k=k(dₘ₊₁, dₘ₊₁) is a kernel value, and the property of the kernel value is represented by an inner product of the feature vector to minimize the above formula to obtain the optimum coefficient vector α=K⁻¹k, so as to obtain:
δ=k(dₘ₊₁,dₘ₊₁)−k^{T}a
based on δ, whether the online data is actively sampled and added into the cached data is determined;
S33: when labeled data is newly added, caching the newly added data in two cases:
S331: if the memory window of the labeled data does not reach an upper limit, directly adding the newly added data into the memory window, and updating the cached data δ for evaluating subsequent memory, calculation formulae being as follows:
$${δ}^{i} = k ( {d}_{i} , {d}_{i} ) - {k}_{new}^{iT} {a}_{n e w}^{i}$$
$${k}_{new}^{i} = {[ {k}_{old}^{i} {k}_{i , m + 1} ]}^{T}$$
$${a}_{new}^{i} = \frac{1}{{γ}_{i}} [ \begin{matrix}{γ}_{i} {a}_{old}^{i} + {α}_{i} {α}_{i}^{T} {k}_{old}^{i} - {k}_{i , m + 1} {α}_{i} \\ - {α}_{i}^{T} {k}_{old}^{i} + {k}_{i , m + 1}\end{matrix} ]$$
$${α}_{i} = {( {K}_{old}^{i} )}^{- 1} {k}_{m + 1}$$
$${γ}_{i} = {k}_{m + 1} - {k}_{m + 1}^{T} {α}_{i}$$
wherein δⁱ represents a degree of information of the i^{th} data, k(dᵢ, dᵢ) represents the kernel value of dᵢ itself,
$${a}_{n e w}^{i}$$
represents a linear correlation coefficient after the new data is added,
$${a}_{old}^{i}$$
represents a linear correlation coefficient before the new data is added, k_{i,m+1} represents a kernel value of the iₜₕ data and the new data,
$${k}_{old}^{i}$$
represents a kernel vector before the new data is added,
$${K}_{old}^{i}$$
represents a kernel matrix before the new data is added, kₘ₊₁ represents a kernel vector between the cached data and the new data, and kₘ₊₁ represents a kernel value of the newly added data itself;
S332: if the memory window of the labeled data has reached the upper limit, deleting data with the smallest δ in the memory data to clear memory for the newly added data, wherein δ is calculated based on the following formulae:
$${δ}^{i} = k ( {d}_{i} , {d}_{i} ) - {k}_{new}^{iT} {a}_{n e w}^{i}$$
$${a}_{n e w}^{i} = A {k}_{n e w}^{i}$$
$${k}_{n e w}^{i} = {[ {k}_{old ( 1 ; j )}^{i} {k}_{i , m + 1} {k}_{old ( j : m )}^{i} ]}^{T}$$
$$A = {A}^{*} - \frac{{{row}_{j} [ {A}^{*} ]}^{T} {r}^{T} {A}^{*}}{1 + {r}^{T} {{row}_{j} [ {A}^{*} ]}^{T}}$$
$${A}^{*} = {( {K}_{old}^{i} )}^{- 1} - \frac{{( {K}_{o l d}^{i} )}^{- 1} r {row}_{j} [ {( {K}_{old}^{i} )}^{- 1} ]}{1 + {r}^{T} {{row}_{j} [ {( {K}_{old}^{i} )}^{- 1} ]}^{T}}$$
$$r = {k}_{m + 1} - {{row}_{j} [ {K}_{old}^{i} ]}^{T}$$
wherein δⁱ represents the degree of information of the iₜₕ data, j represents an index of the replaced data, kₘ₊₁ represents a kernel value of the new data, and rowⱼ[A*] represents the j^{th} line of a given matrix A*; and
S34: to simulate attenuation of the informativeness of the data over time, adding a forgetting factor related to time for updating δ, wherein a calculation formula is as follows:
$${λ}^{i} ( t ) = exp ( - \frac{{( t - {t}_{i} )}^{2}}{2 h} )$$
wherein λ represents the forgetting factor, t represents a current time, tᵢ represents a time when the data is added into the memory, and h represents a forgetting strength;
δⁱ=λⁱδⁱ.

5. The lightweight active online modeling method integrating mechanism and dynamic memory according to claim 1, wherein step S4 specifically comprises:
S41: analyzing a process mechanism to vary a process with a small time lag into a basic variable, taking a continuous time sequence of the basic variable with a length l at a moment i in real time, and taking a continuous time sequence of the remaining process variable with a length l at a moment i;
S42: calculating the maximum information coefficient of the remaining process sequence and a basic sequence at different time lags, wherein calculation formulae are as follows:
$$MIC ( x , y ) = {max}_{xy < B ( n )} \frac{I ( x , y )}{{log}_{2} ( min ( x , y ) )}$$
$$I ( x , y ) = {\sum }_{x ∈ X} {\sum }_{y ∈ Y} P ( x , y ) {log}_{2} \frac{P ( x , y )}{P ( x ) P ( y )}$$
wherein l(x,y) is a mutual information value between x and y, x and y are two sequence data, P(x) and P(y) are probability density functions of x and y, P(x,y) is a joint probability density function, B(n) is 0.5 power of a total sample size n, and time delay corresponding to the maximum time lag sequence with the maximum information coefficient is time delay between the remaining process variable and the basic variable; and
S43: performing online evaluation and monitoring on a time lag relation between the process variable and the basic variable, and when it is detected that a time lag relation changes, considering that the mechanism state changes, and a real drift occurs in the process.

6. The lightweight active online modeling method integrating mechanism and dynamic memory according to claim 1, wherein step S5 specifically comprises:
S51: evaluating the online data representative index in real time, determining and screening representative data based on a threshold to further evaluate the informativeness of the data, and if the informativeness also meets a high informativeness characteristic, i.e., when a cache is not full, the online data δ is greater than a predetermined threshold and when the cache reaches an upper limit, the online data δ is greater than the minimum δ in the cache, triggering an active sampling mechanism; and
S52: parallelly monitoring the process mechanism state in real time, and when a time lag change exceeds a predetermined threshold, considering that the mechanism changes to trigger the active sampling mechanism.

7. The lightweight active online modeling method integrating mechanism and dynamic memory according to claim 1, wherein step S6 specifically comprises:
S61: a prediction formula for original Gaussian process regression being as follows:
y*=K(X*,X)K(X,X)⁻¹y K(X*,X*)=K(X*,X)K(X,X)⁻¹K(X,X*)
wherein X represents a process variable of existing data, X* represents a process variable of data to be predicted, y is an output of existing data, y* is an output to be predicted, and K represents a covariance matrix;
S62: when the memory of the labeled data does not reach an upper limit, calculating the incremental update of the covariance matrix
$${K}_{𝔫 e w}^{i}$$
by the following formula:
$${K}_{n e w}^{i} = [ \begin{matrix}{K}_{old}^{i} & {k}_{m + 1} \\ {k}_{m + 1}^{T} & {k}_{m + 1}\end{matrix} ]$$
directly expanding the covariance matrix, wherein an inverse matrix calculation formula for the expanded covariance matrix is as follows:
$${( {K}_{n e w}^{i} )}^{- 1} = \frac{1}{{γ}_{i}} [ \begin{matrix}{{γ}_{i} ( {K}_{old}^{i} )}^{- 1} + {α}_{t} {α}_{t}^{T} & - {α}_{i} \\ - {a}_{i}^{T} & 1\end{matrix} ]$$
$${α}_{i} = {( {K}_{old}^{i} )}^{- 1} {k}_{m + 1}$$
$${γ}_{i} = {k}_{m + 1} - {α}_{i}^{T} {k}_{m + 1}$$
realizing incremental learning of a Gaussian process regression model that requires only local parameter calculation; and
S63: when data is newly added and the memory of the labeled data has reached the upper limit, replacing the data with minimum δ in the memory with the new data, and calculating the incremental update of the covariance matrix
$${K}_{new}^{i}$$
by the following formula:
$${K}_{n e w}^{i} = [ \begin{matrix}{K}_{old ( 1 ; j )}^{i} & {k}_{m + 1 ( 1 ; j )} & {K}_{o ld ( j ; m )}^{i} \\ {k}_{m + 1 ( 1 ; j )}^{T} & {k}_{m + 1} & {k}_{m + 1 ( j ; m )}^{T} \\ {K}_{o l d ( j ; m )}^{i T} & {k}_{m + 1 ( j ; m )} & {K}_{o ld ( j ; m )}^{i}\end{matrix} ]$$
j is an index of the replaced data, kₘ₊₁ represents a kernel vector between the cached data and the new data, kₘ₊₁ represents a kernel value of the newly added data itself, and an inverse matrix of the new covariance matrix is calculated based on the following formulae:
$${( {K}_{n e w}^{i} )}^{- 1} = A = {A}^{*} - \frac{{{row}_{j} [ {A}^{*} ]}^{T} {r}^{T} {A}^{*}}{1 + {r}^{T} {{row}_{j} [ {A}^{*} ]}^{T}}$$
$${A}^{*} = {( {K}_{o l d}^{i} )}^{- 1} - \frac{{( {K}_{o l d}^{i} )}^{- 1} r {row}_{j} [ {( {K}_{old}^{i} )}^{- 1} ]}{1 + {r}^{T} {{row}_{j} [ {( {K}_{old}^{i} )}^{- 1} ]}^{T}}$$
$$r = {k}_{m + 1} - {{row}_{j} [ {K}_{old}^{i} ]}^{T}$$
